(19) United States
(12) Patent Application Publication
(10) Pub. No.: US 2019/0374875 A1
(43) Pub. Date: Dec. 12, 2019

(54) COLUMN, COLUMN FILLING APPARATUS, COLUMN FILLING SYSTEM, AND COLUMN PROCESSING METHOD

(71) Applicant: JNC CORPORATION, Tokyo (JP)

(72) Inventors: Naoki YAMANAKA, Kanagawa (JP); Masami TODOKORO, Tokyo (JP)

(73) Assignee: JNC CORPORATION, Tokyo (JP)

(21) Appl. No.: 16/432,929

(22) Filed: Jun. 6, 2019

(30) Foreign Application Priority Data
Jun. 8, 2018 (JP) 2018-110250

(51) Int. Cl. B01D 15/20; G01N 30/60

(52) U.S. Cl. CPC B01D 15/206; G01N 2030/565; G01N 30/606

(57) ABSTRACT

A column filling apparatus mainly includes a tank, a stirrer being an agitator, a pump, a resin bottle, first to eleventh pipes, first to fourth valves composed of three-way valves, and fifth and sixth valves composed of two-way valves. A suction port is mounted on a leading end of the fifth pipe, and the suction port is inserted into an inner part from a top opening of the resin bottle. The other end of the fifth pipe is connected to the first valve. The first valve is connected to the first pipe, the second pipe, and the fifth pipe, and connects or disconnects these pipes to or from each other. An end of the first pipe is mounted near a bottom of the tank, and is opened near an inner bottom surface of the tank.

### CROSS-REFERENCE TO RELATED APPLICATION

This application claims the priority benefit of Japan application serial no. 2018-110250, filed on Jun. 8, 2018. The entirety of the above-mentioned patent application is hereby incorporated by reference herein and made a part of this specification.

### BACKGROUND OF THE INVENTION

### Field of the Invention

The present invention relates to a column, a column filling apparatus, a column filling system, and a column processing method used for chromatography column.

### Description of the Related Art

Conventionally, a method for filling a filler in a column used for chromatography is known. The column has a cylindrical shape having an end provided with a filter, and is installed such that the axial direction thereof is along the vertical direction, and the end provided with the filter is located on a vertical upper side. Slurry is injected into the column from a lower end in the gravity direction. At this time, the filter does not transmit a filler, but transmits only liquid, and therefore the filler does not flow out from a column upper end, and only the liquid flows out. Therefore, the filler remains and settles in the column (refer to Japanese Publication of International Patent Application No. 2002-531848).

[PTL 1] Japanese Publication of International Patent Application No. 2002-531848).

### SUMMARY OF THE INVENTION

However, as the filler settles in the column, the thickness of the filler increases. Consequently, the liquid is unlikely to be transmitted through layers of the filler, and resistance against injection of the slurry into the column increases, and the injection speed of the slurry reduces. When the injection speed reduces, the flow speed in a pipe connecting a container storing the slurry and the column becomes slow, and therefore a risk that the inside of the pipe is blocked by the filler occurs.

The present invention has been made in view of problems such as described above, and the present invention provides a column, a column filling apparatus, a column filling system, and a column processing method, in which a filler can be rapidly and easily filled in a chromatography column.

The invention of this application includes the following [1] to [19].

[1] A column filling apparatus comprising: a tank storing liquid and a filler; a transfer pipe transferring slurry from the tank to a column, the slurry comprising the liquid and the filler; and a reflux pipe for refluxing the slurry from the column to the tank.
[2] The column filling apparatus according to [1], wherein the transfer pipe allows the slurry to flow into the column from an upper side with respect to a filling completion position of a filler in the column.
[3] The column filling apparatus according to [1] or [2], wherein the reflux pipe takes out the slurry from the column from an upper side with respect to a filling completion position of a filler in the column.
[4] The column filling apparatus according to any one of [1] to [3], wherein the transfer pipe takes out the slurry from a vicinity of a bottom of the tank.
[5] The column filling apparatus according to any one of [1] to [4], wherein the transfer pipe includes a pump that transfers the slurry from the tank to the column.
[6] The column filling apparatus according to any one of [1] to [5], further comprising an agitator that is provided in the tank, and mixes the liquid and the filler.
[7] The column filling apparatus according to any one of [1] to [6], further comprising: a container storing the liquid and the filler; a container take-out pipe taking out the liquid and the filler from the container; and a container return pipe returning, to the container, the liquid and the filler taken out by the container take-out pipe, wherein the transfer pipe includes a pump that pressure-feeds the slurry from the tank to the column, a first valve provided between the tank and the pump, and a second valve provided between the pump and the column, the container take-out pipe is connected to the first valve, the container return pipe is connected to the second valve, the first valve closes a path between the transfer pipe and the tank, and opens a path between the transfer pipe and the container take-out pipe, the second valve closes a path between the transfer pipe and the column, and opens a path between the transfer pipe and the container return pipe, and the pump takes out the liquid and the filler from the container through the container take-out pipe, and returns the liquid and the filler to the container through the container return pipe.
[8] The column filling apparatus according to any one of [1] to [7], further comprising: a container storing the liquid and the filler; and a container take-out pipe taking out the liquid and the filler from the container, wherein the transfer pipe includes a pump that pressure-feeds the slurry from the tank to the column, a first valve provided between the tank and the pump, and a third valve provided between the pump and the column, the reflux pipe includes a fourth valve provided between the column and the tank, a pipe connecting the third valve and the fourth valve is provided, the container take-out pipe is connected to the first valve, the first valve closes a path to the tank in the transfer pipe, and opens a path from the container take-out pipe to the transfer pipe, the third valve closes a path to the column in the transfer pipe, and opens a path from the pump to the pipe, the fourth valve closes a path to the column in the reflux pipe, and opens a path from the pipe to the tank, and the pump takes out the liquid and the filler from the container through the container take-out pipe, and transfers the liquid and the filler to the tank.
[9] The column filling apparatus according to any one of [1] to [8], further comprising: a container storing the liquid and the filler; a tank take-out pipe taking out the liquid from the tank; and a container return pipe returning, to the container, the liquid taken out by the tank take-out pipe, wherein the transfer pipe includes a pump that pressure-feeds the slurry from the tank to the column, a first valve provided between the tank and the pump, and a second valve provided between the pump and the column, the tank take-out pipe is connected to the first valve, the container return pipe is connected to the second valve, the first valve closes a path between the transfer pipe and the tank, and opens a path between the transfer pipe and the tank take-out pipe, the second valve closes a path between the transfer pipe and the column, and opens a path between the transfer pipe and the container return pipe, and the pump takes out the liquid from the tank through the tank take-out pipe, discharges the liquid to outside through the container return pipe, and adjusts concentration of the filler to the liquid.
[10] The column filling apparatus according to any one of [1] to [9], further comprising a column bottom valve provided in a bottom of the column, wherein the column bottom valve allows the liquid in the column to flow out to outside.
[11] The column filling apparatus according to any one of [1] to [10], further comprising a tank take-out pipe that takes out the liquid from the tank, wherein the transfer pipe includes a pump that pressure-feeds the slurry from the tank to the column, and a first valve provided between the tank and the pump, the tank take-out pipe is connected to the first valve, the first valve closes a path between the transfer pipe and the tank, and opens a path between the transfer pipe and the tank take-out pipe, the pump takes out the liquid from the tank through the tank take-out pipe, and discharges the liquid to the column through the transfer pipe, and produces slurry by mixing the filler and the liquid in the column, and the reflux pipe refluxes the slurry from the column to the tank.
[12] The column filling apparatus according to any one of [1] to [10], further comprising a tank take-out pipe that takes out the liquid from the tank, wherein the transfer pipe includes a pump that pressure-feeds the slurry from the tank to the column, and a second valve provided between the pump and the column, a column bottom valve that is provided in a bottom of the column, and allows the liquid in the column to flow out to outside, and a column bottom connection pipe connecting the second valve and the column bottom valve are further provided, the second valve opens a path between the transfer pipe and the column bottom connection pipe, and the pump takes out the liquid from the tank through the tank take-out pipe, and injects the liquid from the bottom of the column to inside through the column bottom connection pipe and the column bottom valve.
[13] The column filling apparatus according to any one of [1] to [10], further comprising: a container take-out pipe that takes out at least the liquid from the column; and a container return pipe that returns, to the column, the liquid taken out by the container take-out pipe, wherein the transfer pipe includes a pump that pressure-feeds the slurry from the tank to the column, a first valve provided between the tank and the pump, and a second valve provided between the pump and the column, the container take-out pipe is connected to the first valve, the container return pipe is connected to the second valve, the first valve closes a path between the transfer pipe and the tank, and opens a path between the transfer pipe and the container take-out pipe, the second valve closes a path between the transfer pipe and the column, and opens a path between the transfer pipe and the container return pipe, and the pump takes out at least the liquid from the column through the container take-out pipe, returns at least the liquid to the column through the container return pipe, and produces slurry by mixing the filler and the liquid in the column.
[14] The column filling apparatus according to any one of [1] to [13], wherein a slurry surface in the tank is disposed on an upper side in a gravity direction with respect to a liquid level at which the liquid is discharged to outside in the column.
[15] A column processing method comprising the steps of: storing liquid and a filler in a tank; transferring slurry from the tank to a column, the slurry comprising the liquid and the filler; and refluxing the slurry from the column to the tank.
[16] A column comprising: a cylindrical column body capable of filling a filler up to a filling completion position; and a pipe mounting port provided between an axial end near the filling completion position and the filling completion position on a side surface of the column body.
[17] The column according to [16], comprising a piston capable of axially moving inside the column body, and capable of compressing the filler, wherein the piston is capable of moving beyond the filling completion position from the axial end near the filling completion position.
[18] A column filling system comprising: a column comprising a cylindrical column body; and a column filling apparatus according to [1], wherein the column filling apparatus includes a lid that detachably blocks an axial end of the column body, and the transfer pipe and the reflux pipe penetrate the lid to be inserted into the column body.
[19] A column filling system comprising: a column filling apparatus according to [1]; and a column according to [16].

According to the present invention, a column, a column filling apparatus, a column filling system, and a column processing method, in which a filler can be rapidly and easily filled in a chromatography column, are obtained.

### BRIEF DESCRIPTION OF THE DRAWINGS

FIG. 1 is a block diagram of a column filling apparatus according to a first embodiment;

FIG. 2 is a flowchart illustrating a column processing method;

FIG. 3 is a block diagram of the column filling apparatus in a process of producing slurry;

FIG. 4 is a block diagram of the column filling apparatus in a process of transferring the slurry to a tank;

FIG. 5 is a block diagram of the column filling apparatus in a process of adjusting the concentration of the slurry;

FIG. 6 is a block diagram of the column filling apparatus in a process of transferring the slurry to a first column;

FIG. 7 is a block diagram of the column filling apparatus in a process of settling the filler in the first column;

FIG. 8 is a block diagram of the column filling apparatus in a process of recovering the filler from the first column;

FIG. 9 is a block diagram of the column filling apparatus in a process of recovering the filler from the first column;

FIG. 10 is a block diagram of the column filling apparatus in a process of recovering the filler from the first column;

FIG. 11 is a block diagram of a column filling apparatus comprising a second column according to a second embodiment;

FIG. 12 is a sectional view of the second column on a plane orthogonal to the axis of the second column;

FIG. 13 is a sectional view of the second column on the plane orthogonal to the axis of the second column;

FIG. 14 is a graph illustrating time change of a draining amount from a fifth valve; and

FIG. 15 is a graph illustrating a chromatographic analysis result after filling.

### DETAILED DESCRIPTION OF THE PREFERRED EMBODIMENTS

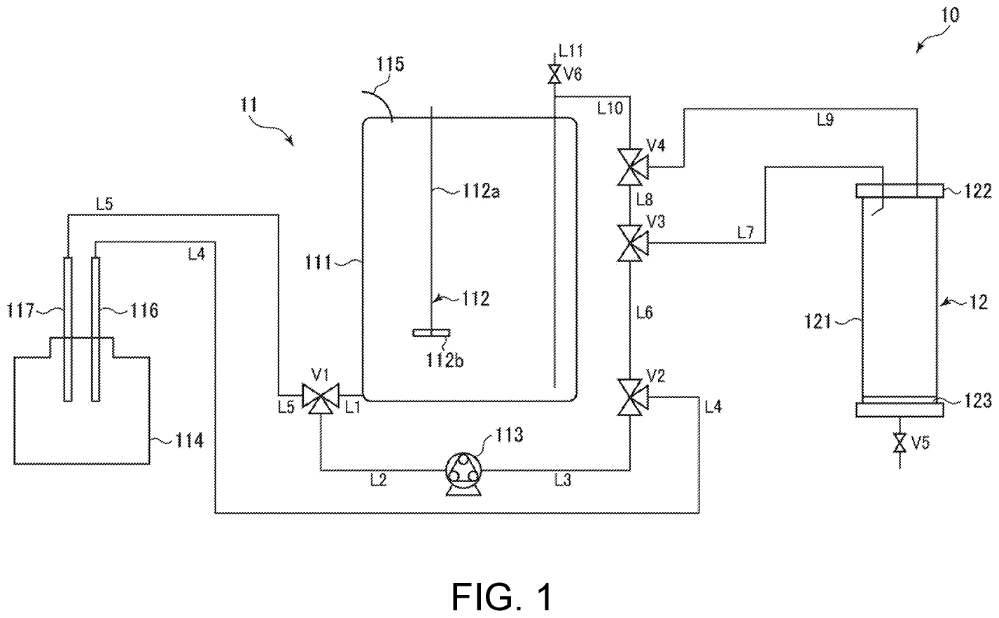

Hereinafter, a first column 12, a column filling apparatus 11, and a column filling system 10 according to the present invention will be described with reference to FIGS. 1 to 3. The column filling system 10 mainly includes the column filling apparatus 11, and the first column 12.

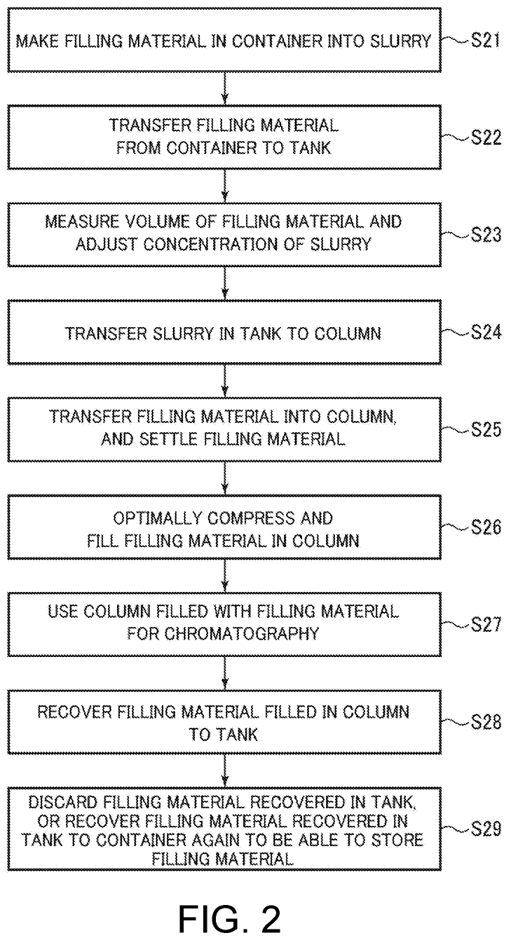

The column filling apparatus 11 mainly includes a tank 111, a stirrer 112 being an agitator, a pump 113, a resin bottle 114, first to eleventh pipes L1 to L11, first to fourth valves V1 to V4 composed of three-way valves, and fifth and sixth valves V5, V6 composed of two-way valves. The fifth valve V5 forms a column bottom valve. The resin bottle 114 is a container storing slurry composed of filler and liquid, and is illustrated as a container in FIG. 2. The filler is made of resin such as cellulose, agarose, and polymer (acrylic polymer or the like). A suction port 117 is mounted on a leading end of the fifth pipe L5, and the suction port 117 is inserted into an inner part from a top opening of the resin bottle 114. The other end of the fifth pipe L5 is connected to the first valve V1. The first valve V1 is connected to the first pipe L1, the second pipe L2, and the fifth pipe L5, and connects or disconnects these pipes to or from each other. An end of the first pipe L1 is mounted near a bottom of the tank 111, and is opened near an inner bottom surface of the tank 111.

The tank 111 is a container having predetermined capacity, and includes a vent port 115 opened to the atmosphere. The stirrer 112 is provided by being inserted from the outside of the tank 111. The stirrer 112 includes a stirring bar 112b mounted on a leading end of a rotary shaft 112a, and the stirring bar 112b is rotated by the rotary shaft 112a, and stirs slurry stored in the tank 111. A leading end of the tenth pipe L10 inserted from a top of the tank 111 extends up to the vicinity of the inner bottom surface of the tank 111.

The tenth pipe L10 is a three-way pipe, and has an end connected to the inside of the tank 111, an end connected to the sixth valve V6, and a remaining end connected to the fourth valve V4. The sixth valve V6 is installed on an upper side in the gravity direction with respect to the first column 12, is connected to the tenth pipe L10 and the eleventh pipe L11, and connects or disconnects these pipes to or from each other. An end of the eleventh pipe L11 is opened to the atmosphere. The fourth valve V4 is connected to the tenth pipe L10, the eighth pipe L8, and the ninth pipe L9, and connects or disconnects these pipes to or from each other. The other end of the eighth pipe L8 is connected to the third valve V3, and the other end of the ninth pipe L9 is connected to the first column 12 described below. The third valve V3 is connected to the eighth pipe L8, the seventh pipe L7, and the sixth pipe L6, and connects or disconnects these pipes to or from each other. The other end of the sixth pipe L6 is connected to the second valve V2, and the other end of the seventh pipe L7 is connected to the first column 12 described below. The second valve V2 is connected to the third pipe L3, the fourth pipe L4, and the sixth pipe L6, and connects or disconnects these pipes to or from each other. The other end of the third pipe L3 is connected to the pump 113. The fifth valve V5 is connected to a bottom of a first column tube 121.

The pump 113 is a bidirectional pump, is connected to the second pipe L2 and the third pipe L3, and pressure-feeds liquid, slurry or the like from the second pipe L2 to the third pipe L3, or from the third pipe L3 to the second pipe L2. A discharge port 116 is mounted on the other end of the fourth pipe L4, and the discharge port 116 is inserted into an inner part from the top opening of the resin bottle 114.

The first column 12 mainly includes the bottomed cylindrical first column tube 121, a lid 122, and a filter 123. The filter 123 is a disk-shaped filter having such a pore diameter as to enable passing of liquid but not as to enable passing of a filler. The outer diameter of the filter 123 is substantially the same as the inner diameter of the first column tube 121. The filter 123 is provided so as to be in close contact with the inner bottom surface by being inserted from the top opening before the filler is transferred to the inside of the first column tube 121. Consequently, while the liquid can pass from the inside of the first column tube 121 toward the fifth valve, the filler cannot pass. The lid 122 is connected to the seventh pipe L7 and the ninth pipe L9, is detachably mounted on a top opening of the first column tube 121, and blocks an axial end of the first column tube 121. In this state, a leading end of the seventh pipe L7 penetrates the lid 122 to reach an inner part from an outer part of the first column 12, and is provided in such a shape and such a position that the slurry discharged from the leading end swirls inside the first column tube 121. A leading end of the ninth pipe L9 is provided so as to penetrate the lid 122 up to such a position as to be substantially flush with a surface inside the first column 12 in the lid 122. The first column tube 121 forms a column body.

Now, a column processing method implemented by a column filling apparatus and a column filling system will be described with reference to FIGS. 2 to 10.

FIG. 2 is a flowchart illustrating the column processing method. Steps S21 to S26 indicate processes of filling slurry in the first column 12, and Steps S28 and S29 indicate processes of recovering the slurry from the first column 12. First, Steps S21 to S26 will be described with reference to FIGS. 2 to 7.

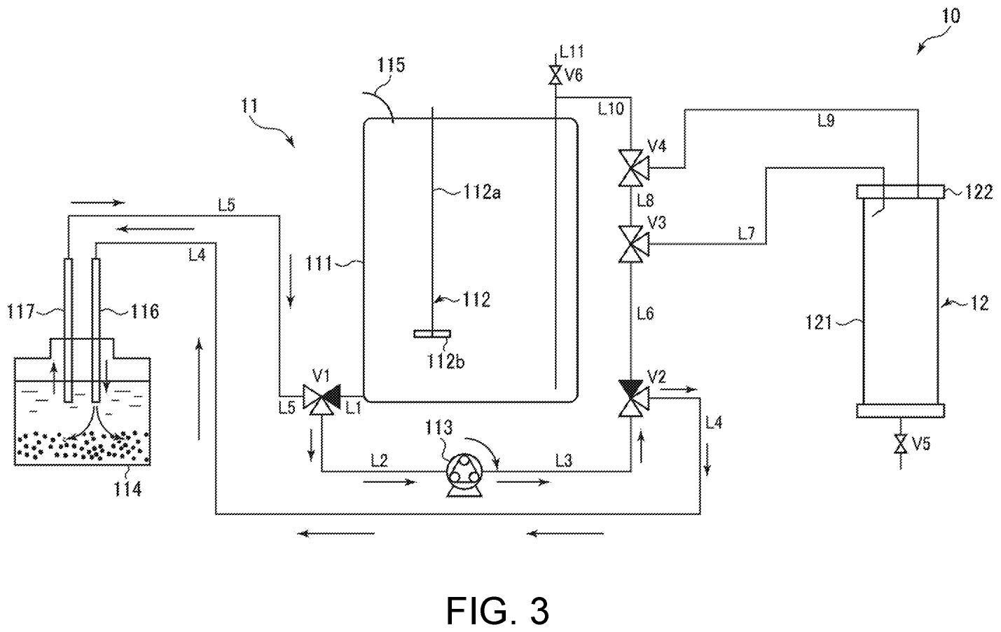

Initial Step S21 is a process of stirring a filler and liquid in the resin bottle 114 to generate fluidity, and producing slurry. Hereinafter, Step S21 will be described with reference to FIG. 3. In this process, the first valve V1 opens a path between the fifth pipe L5 and the second pipe L2, and closes a path between the fifth pipe L5 and the second pipe L2, and the first pipe L1. Additionally, the second valve V2 opens a path between the third pipe L3 and the fourth pipe L4, and closes a path between the third pipe L3 and the fourth pipe L4, and the sixth pipe L6. Consequently, the suction port 117 is connected to the discharge port 116 through the fifth pipe L5, the first valve V1, the second pipe L2, the pump 113, the third pipe L3, the second valve V2, and the fourth pipe L4. Then, the pipes, the pump, and the valves from the suction port 117 to the discharge port 116 are filled with liquid composing slurry. In this state, when the pump 113 is driven such that the liquid flows from the second pipe L2 to the third pipe L3, liquid in the resin bottle 114 is sucked from the suction port 117, and is discharged into the resin bottle 114 from the discharge port 116 through the pipes, the pump, and the valves. A filler in the resin bottle 114 is stirred together with the liquid by flow of the discharged liquid. This process is continued for a predetermined time, so that the filler and the liquid are mixed to produce slurry. At this time, the fifth pipe L5 forms a container take-out pipe, and the fourth pipe L4 forms a container return pipe.

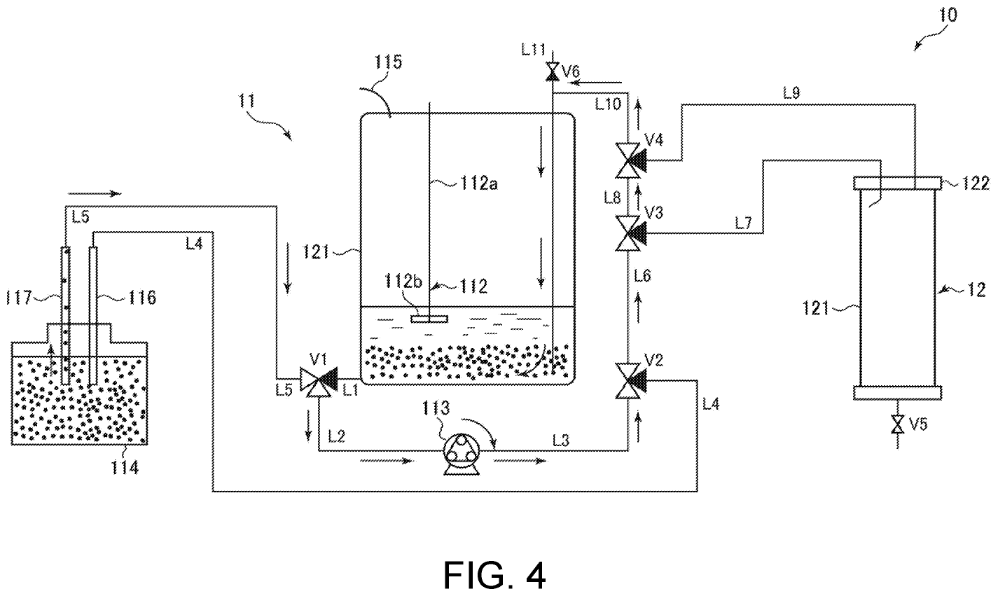

Step S22 is a process of transferring the slurry in the resin bottle 114 to the tank 111. Hereinafter, Step S22 will be described with reference to FIG. 4. In this process, the first valve V1 opens the path between the fifth pipe L5 and the second pipe L2, and closes the path between the fifth pipe L5 and the second pipe L2, and the first pipe L1. Additionally, the second valve V2 opens a path between the third pipe L3 and the sixth pipe L6, and closes a path between the third pipe L3 and the sixth pipe L6, and the fourth pipe L4. The third valve V3 opens a path between the sixth pipe L6 and the eighth pipe L8, and closes a path between the sixth pipe L6 and the eighth pipe L8, and the seventh pipe L7. The fourth valve V4 opens a path between the eighth pipe L8 and the tenth pipe L10, and closes a path between the eighth pipe L8 and the tenth pipe L10, and the ninth pipe L9. The sixth valve V6 is closed, and closes a path between the tenth pipe L10 and the eleventh pipe L11.

Consequently, the suction port 117 is connected to the tank 111 through the fifth pipe L5, the first valve V1, the second pipe L2, the pump 113, the third pipe L3, the second valve V2, the sixth pipe L6, the third valve V3, the eighth pipe L8, the fourth valve V4, and the tenth pipe L10. In this state, when the pump 113 is driven such that the liquid flows from the second pipe L2 to the third pipe L3, the slurry in the resin bottle 114 is sucked from the suction port 117, and is discharged into the tank 111 from the tenth pipe L10 through the pipes, the pump, and the valves. This process is continued for a predetermined time, so that the slurry in the resin bottle 114 is transferred to the tank 111.

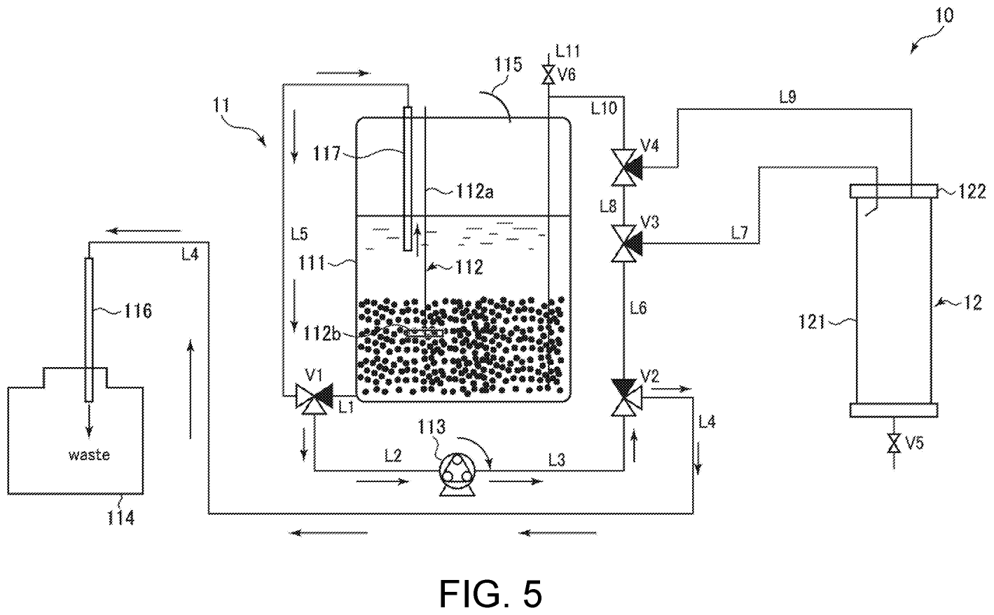

Step S23 is a process of adjusting the concentration of the slurry in the tank 111. Hereinafter, Step S23 will be described with reference to FIG. 5. First, after the tank 111 is allowed to stand, and the filler is completely precipitated, the volume of the filler in the tank 111 is measured on the basis of the volume of the precipitated filler. In the tank 111, a scale (not illustrated) is indicated, and the volume of the filler can be easily measured by referring this scale.

Now, an amount of the liquid in the tank is adjusted, so that the concentration of the filler in the slurry is made to be desired concentration. Hereinafter, details will be described. Herein, the first valve V1 opens the path between the fifth pipe L5 and the second pipe L2, and closes the path between the fifth pipe L5 and the second pipe L2, and the first pipe L1. Additionally, the second valve V2 opens the path between the third pipe L3 and the fourth pipe L4, and closes the path between the third pipe L3 and the fourth pipe L4, and the sixth pipe L6. Consequently, the suction port 117 is connected to the discharge port 116 through the fifth pipe L5, the first valve V1, the second pipe L2, the pump 113, the third pipe L3, the second valve V2, and the fourth pipe L4. The suction port 117 is pulled out from the resin bottle 114, and inserted into the tank 111. At this time, the fifth pipe L5 forms a tank take-out pipe, and the fourth pipe L4 forms a container return pipe. In this state, when the pump 113 is driven such that the liquid flows from the second pipe L2 to the third pipe L3, liquid in the tank 111 is sucked from the suction port 117, and is discharged into the resin bottle 114 from the discharge port 116 through the pipes, the pump, and the valves. Consequently, it is possible to reduce the amount of the liquid in the tank 111. On the other hand, when the pump 113 is driven such that the liquid flows from the third pipe L3 to the second pipe L2, the liquid in the resin bottle 114 is sucked from the discharge port 116, and is discharged into the tank 111 from the suction port 117 through the pipes, the pump, and the valves. Consequently, it is possible to increase the amount of the liquid in the tank 111. These processes are continued for a predetermined time, so that the amount of the liquid in the tank 111 is adjusted, and the concentration of the filler in the slurry is made to be the desired concentration. Herein, the concentration is determined in consideration of the fluidity of the filler or the like, and for example, the concentration of 50 vol. % is used. In a case of the concentration of 50%, slurry whose volume is twice the filler to be transferred to the first column 12 is required. An amount of the filler to be transfer to the first column 12 is less than the volume of the first column 12.

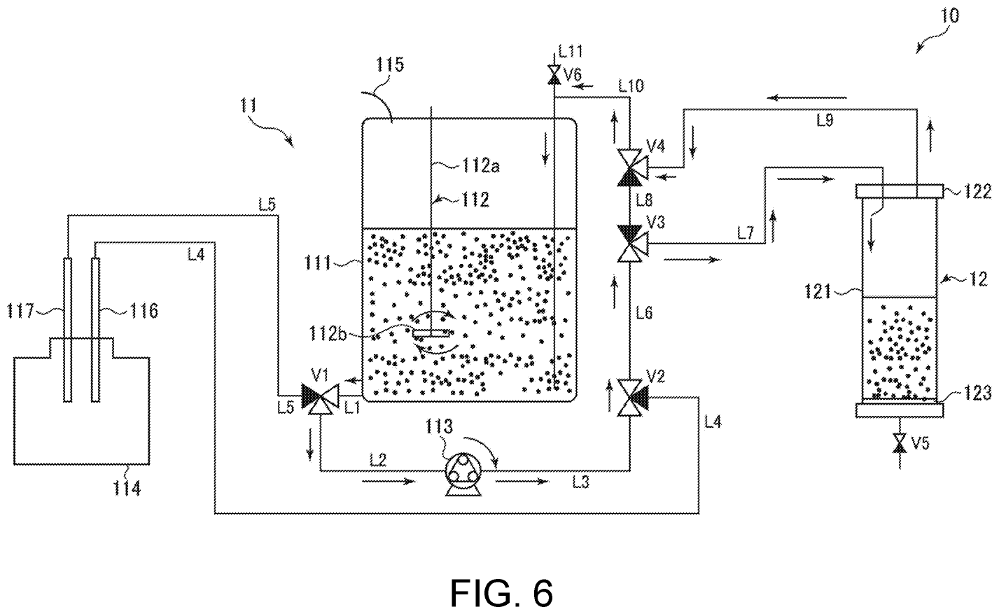

Step S24 is a process of transferring the slurry in the tank 111 to the first column 12. Hereinafter, Step S24 will be described with reference to FIG. 6. In this process, the first valve V1 opens a path between the first pipe L1 and the second pipe L2, and closes a path between the first pipe L1 and the second pipe L2, and the fifth pipe L5. Additionally, the second valve V2 opens a path between the third pipe L3 and the sixth pipe L6, and closes a path between the third pipe L3 and the sixth pipe L6, and the fourth pipe L4. The third valve V3 opens a path between the sixth pipe L6 and the seventh pipe L7, and closes a path between the sixth pipe L6 and the seventh pipe L7, and the eighth pipe L8. The fourth valve V4 opens a path between the ninth pipe L9 and the tenth pipe L10, and closes a path between the ninth pipe L9 and the tenth pipe L10, and the eighth pipe L8. The fifth valve V5 is closed. The sixth valve V6 is closed, and closes a path between the tenth pipe L10 and the eleventh pipe L11. Consequently, the first pipe L1 mounted near the bottom of the tank 111 is connected to the inside of the first column 12 through the first valve V1, the second pipe L2, the pump 113, the third pipe L3, the second valve V2, the sixth pipe L6, the third valve V3, and the seventh pipe L7, and the ninth pipe L9 connected to the first column 12 is connected to the inside of the tank 111 through the fourth valve V4, and the tenth pipe L10. Herein, the first pipe L1, the second pipe L2, the third pipe L3, the sixth pipe L6, and the seventh pipe L7 form a transfer pipe, and the ninth pipe L9 and the tenth pipe L10 form a reflux pipe.

First, the stirring bar 112b is rotated, the slurry stored in the tank 111 is stirred for a predetermined time, and uniform slurry is prepared. Thereafter, when the pump 113 is driven such that the slurry flows from the second pipe L2 to the third pipe L3, the slurry in the tank 111 is sucked from the bottom of the tank 111 to the first pipe L1, and is discharged into the first column 12 from the seventh pipe L7 through the pipes, the pump, and the valves. Herein, the seventh pipe L7 allows the slurry to flow from an upper side with respect to a filling completion position of the filler in the first column 12. Consequently, the slurry in the tank 111 is transferred to the first column 12. Additionally, the air in the first column 12 flows into the tank 111 through the ninth pipe L9, the fourth valve V4, and the tenth pipe L10. Consequently, pressure rise in the first column 12, and pressure drop in the tank 111 are offset, slurry in the tank 111 are smoothly transferred to the first column 12, and a first column 12 is filled with the slurry.

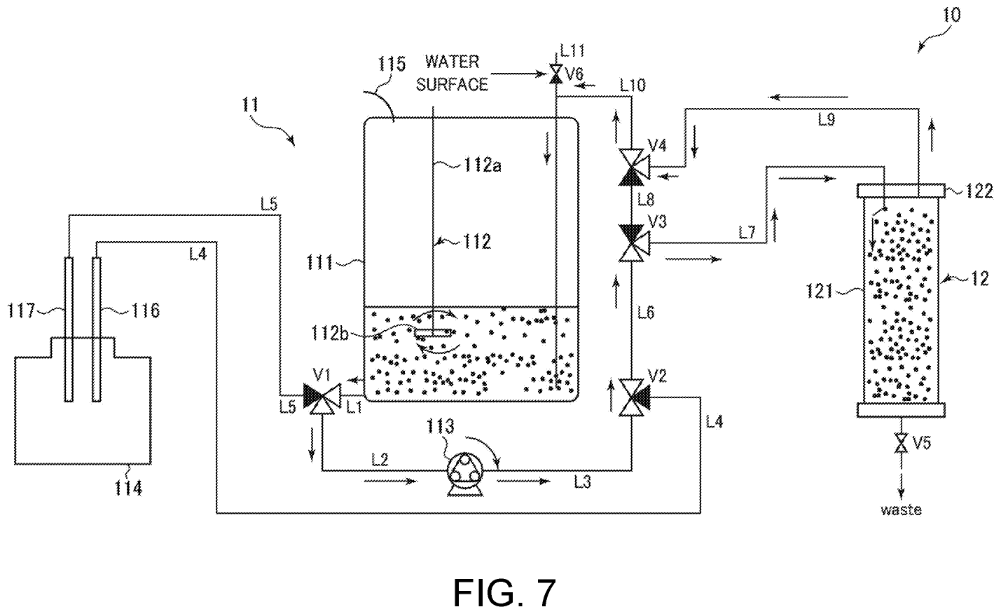

Step S25 is a process of settling the filler in the first column 12. Hereinafter, Step S25 will be described with reference to FIG. 7. This process is different from Step S24 only in that the fifth valve V5 is opened, and other pipes, pump, and valves are connected in a manner similar to Step S24. Herein, for example, in a case where slurry whose concentration is 50% is transferred, when the first column 12 is filled with the slurry, slurry, an amount of which is substantially the same as an amount of slurry in the first column 12, remains in the tank 111. Then, the stirring bar 112b is rotated, and the slurry in the tank 111 is stirred, so that the filler is prevented from being settled. At the same time, while the fifth valve V5 is opened, the pump 113 is driven in a manner similar to Step S24, and the slurry in the tank 111 is transferred to the inside of the first column 12. Then, the transferred slurry is refluxed into the tank 111 through the ninth pipe L9, the fourth valve V4, and the tenth pipe L10. Herein, the ninth pipe L9 takes out slurry from the upper side with respect to the filling completion position of the filler in the first column 12. The liquid in the first column 12 is discharged to the outside through the filter 123, and the opened fifth valve V5, and the filler is stored in the first column 12. The filling completion position is a position at which storing of the filler in the axial direction of the first column tube 121 is completed, and which is previously determined by expecting that the filler is compressed in Step S26 described below. Herein, a slurry surface in the tank 111, that is, a liquid upper surface of the slurry is disposed on the upper side in the gravity direction with respect to a liquid level at which the liquid is discharged to the outside through the fifth valve V5. Consequently, water head pressure is applied to the liquid in the first column 12, and the liquid in the first column 12 is rapidly discharged to the outside.

As described above, in a conventional technology, as filler is settled in the column, the thickness of the filler is increased, so that liquid is unlikely to be transmitted through layers of the filler, resistance against injection of the slurry into the column increases, and the injection speed of the slurry reduces. Consequently, there is a risk that the inside of the pipe is blocked by the filler. However, according to this embodiment, slurry that circulates through the tank 111 and the first column 12 does not transmit the settled filler, and slurry that flows out from the first column 12 through the ninth pipe L9 is supernatant liquid of the slurry in the first column 12, and therefore the concentration thereof is concentration previously adjusted in the tank 111, or less. Accordingly, the flow speed of the slurry in the pipe is not reduced, the slurry always flows, and the inside of the pipe is not blocked by the filler.

Step S26 is a process of optimally compressing and filling the filler in the first column 12. In this process, the pipes, the pump, and the valves are connected in a manner similar to Step S25. It is confirmed that substantially all the filler in the tank 111 is settled in the first column 12, and thereafter the fifth valve V5 is closed. Then, the lid 122 is detached from the first column tube 121, an adapter (not illustrated) is mounted on the first column tube 121. The adapter is mounted, so that the filler in the first column tube 121 is compressed at a predetermined compress ratio. Consequently, the filler is filled in the first column 12. The compress ratio of the filler is predetermined for each filler.

In Step S27, the first column 12 is used for chromatography.

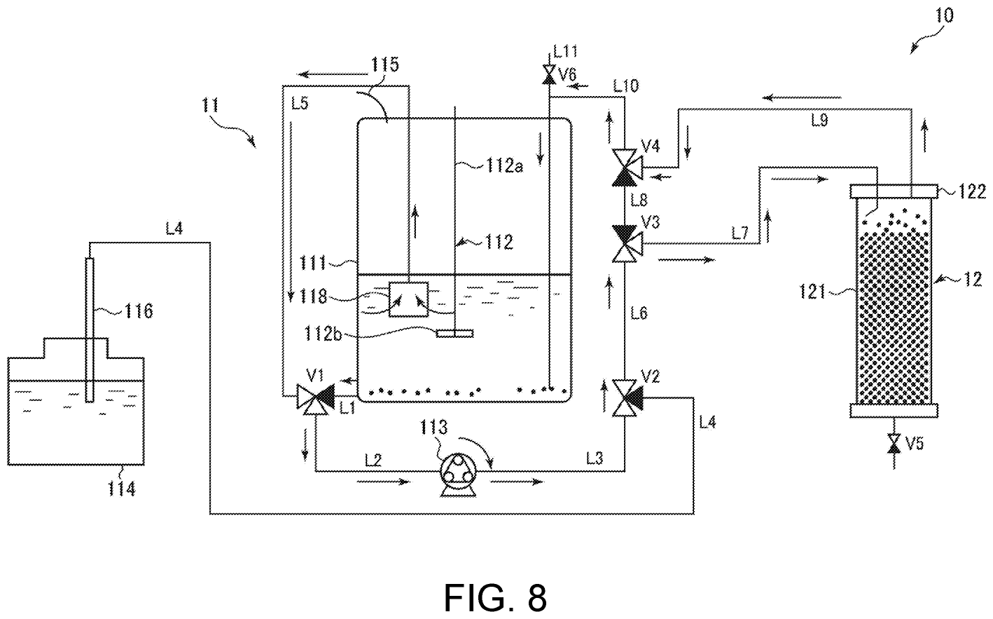

The first column 12 is used for chromatography, and thereafter the filler in the first column is recovered to be reused. Hereinafter, processes of recovering the filler from the first column 12 in Steps S28 and S29 will be described with reference to FIGS. 8 to 10.

The process of recovering the filler from the first column 12 according to Step S28 has three different processes. Hereinafter, each process will be described.

First, a first recovery process will be described with reference to FIG. 8. In the first recovery process, a suction port 118 with a filter is mounted on the leading end of the fifth pipe L5 in place of the suction port 117, the lid 122 connected to the seventh pipe L7 and the ninth pipe L9 is mounted on the top opening of the first column tube 121. Then, the first valve V1 opens the path between the fifth pipe L5 and the second pipe L2, and closes the path between the fifth pipe L5 and the second pipe L2, and the first pipe L1. Additionally, the second valve V2 opens the path between the third pipe L3 and the sixth pipe L6, and closes the path between the third pipe L3 and the sixth pipe L6, and the fourth pipe L4. The third valve V3 opens a path between the sixth pipe L6 and the seventh pipe L7, and closes a path between the sixth pipe L6 and the seventh pipe L7, and the eighth pipe L8. The fourth valve V4 opens a path between the ninth pipe L9 and the tenth pipe L10, and closes a path between the ninth pipe L9 and the tenth pipe L10, and the eighth pipe L8. The fifth valve V5 is closed. The sixth valve V6 is closed, and closes a path between the tenth pipe L10 and the eleventh pipe L11. Consequently, the suction port 118 with a filter is connected to the inside of the first column 12 through the fifth pipe L5, the first valve V1, the second pipe L2, the pump 113, the third pipe L3, the second valve V2, the sixth pipe L6, the third valve V3, and the seventh pipe L7, and the ninth pipe L9 connected to the first column 12 is connected to the inside of the tank 111 through the fourth valve V4, and the tenth pipe L10. At this time, the fifth pipe L5 forms a tank take-out pipe.

First, when the pump 113 is driven such that the liquid flows from the second pipe L2 to the third pipe L3, the liquid in the tank 111 is sucked from the suction port 118 with a filter to the fifth pipe L5, and is discharged into the first column 12 from the seventh pipe L7 through the pipes, the pump, and the valves. Consequently, the liquid in the tank 111 is transferred to the first column 12. The transferred liquid breaks and fluidizes the filler filled in the first column 12. The fluidized filler is mixed with the liquid to become slurry, and flows into the tank 111 through the ninth pipe L9, the fourth valve V4, and the tenth pipe L10. Herein, as described above, the leading end of the seventh pipe L7 is provided in such a shape and such a position that the discharged liquid swirls inside the first column tube 121. Therefore, the liquid can efficiently break and fluidize the filler.

When the first recovery process is started, setting is performed such that the second valve V2 opens the path between the fourth pipe L4 and the third pipe L3, and closes the path between the fourth pipe L4 and the third pipe L3, and the sixth pipe L6, and the pump 113 is driven such that the slurry flows from the third pipe L3 to the second pipe L2. Consequently, liquid in the resin bottle 114 is transferred to the tank 111 through the fourth pipe L4. In the first recovery process, the filler in the tank 111 is recovered by use of this liquid.

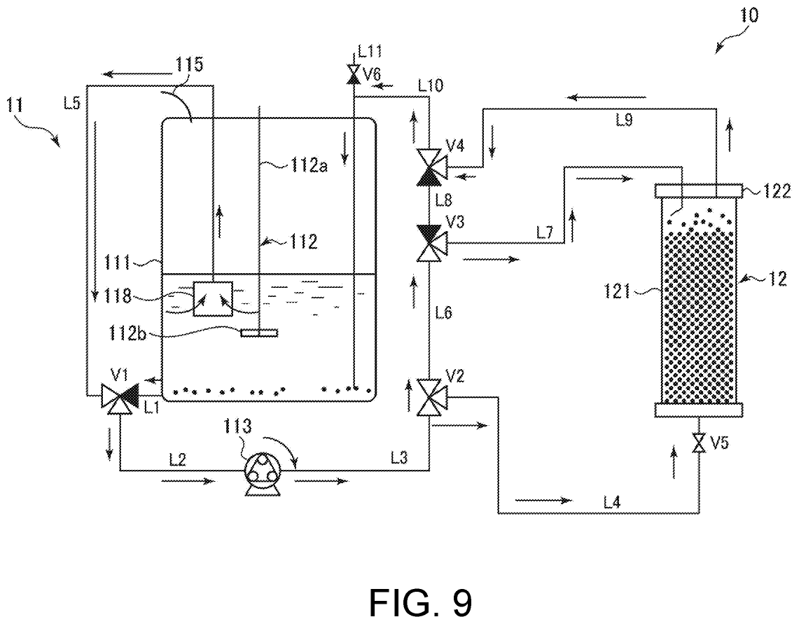

Now, a second recovery process will be described with reference to FIG. 9. The second recovery process is different from the first recovery process in that the second valve V2 opens a path between the third pipe L3, the sixth pipe L6, and the fourth pipe L4, the fourth pipe L4 is connected to the fifth valve V5, and the fifth valve V5 opens a path between the fourth pipe L4 and the inside of the first column 12. Other pipes, pump, and valves are connected in a manner similar to the first recovery process, and therefore description will be omitted. At this time, the fourth pipe L4 forms a column bottom connection pipe, and the fifth pipe L5 forms a tank take-out pipe.

First, when the pump 113 is driven such that the liquid flows from the second pipe L2 to the third pipe L3, the liquid in the tank 111 is sucked from the suction port 118 with a filter to the fifth pipe L5, and is discharged into the first column 12 from the seventh pipe L7 and a bottom of the first column tube 121 through the pipes, the pump, and the valves. Consequently, the liquid in the tank 111 is transferred to the first column 12. The transferred liquid breaks and fluidizes the filler filled in the first column 12. The fluidized filler is mixed with the liquid to become slurry, and flows into the tank 111 through the ninth pipe L9, the fourth valve V4, and the tenth pipe L10. Herein, the liquid that flows from the bottom of the first column tube 121 can break the filler from the bottom, and fluidize the filler. Additionally, the liquid discharged from the leading end of the seventh pipe L7 flows so as to swirl in the first column tube 121, and can break and fluidize the filler. The liquid is injected from the two directions, so that the filler can be efficiently broken and fluidized to be recovered.

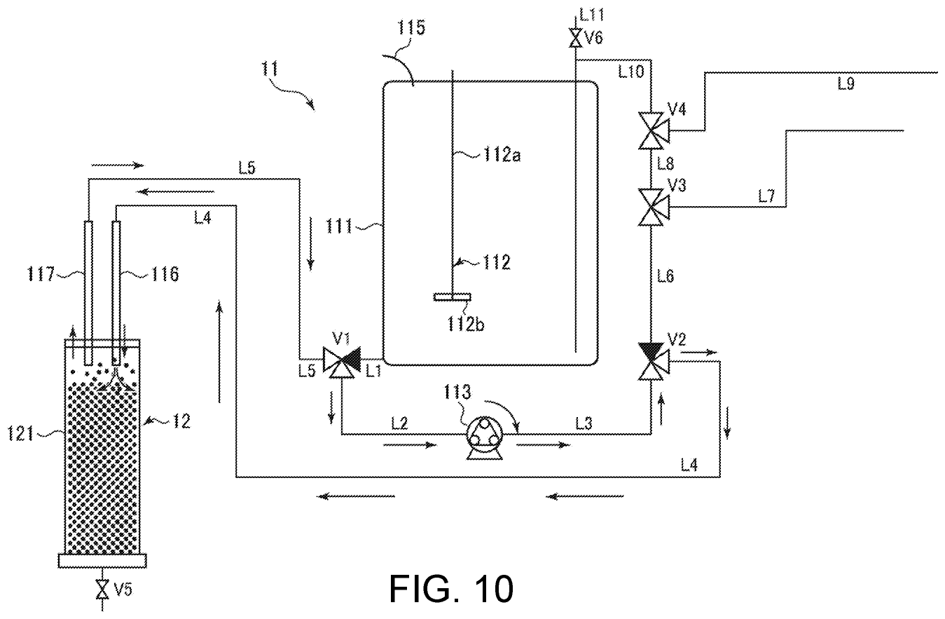

Now, a third recovery process will be described with reference to FIG. 10. In this process, the first valve V1 opens the path between the fifth pipe L5 and the second pipe L2, and closes the path between the fifth pipe L5 and the second pipe L2, and the first pipe L1. Additionally, the second valve V2 opens the path between the third pipe L3 and the fourth pipe L4, and closes the path between the third pipe L3 and the fourth pipe L4, and the sixth pipe L6. At this time, the fourth pipe L4 forms a container return pipe, and the fifth pipe L5 forms a container take-out pipe.

Consequently, the suction port 117 is connected to the discharge port 116 through the fifth pipe L5, the first valve V1, the second pipe L2, the pump 113, the third pipe L3, the second valve V2, and the fourth pipe L4. Then, the pipes, the pump, and the valves from the suction port 117 to the discharge port 116 are filled with liquid composing slurry. In this state, when the pump 113 is driven such that the liquid flows from the second pipe L2 to the third pipe L3, the liquid in the first column tube 121 is sucked from the suction port 117, and is discharged into the first column tube 121 from the discharge port 116 through the pipes, the pump, and the valves. The filler in the first column tube 121 is stirred together with the liquid by flow of the discharged liquid. When this process is continued for a predetermined time, the filler and the liquid are mixed to produce slurry. Then, in a manner similar to Step S22, the slurry is transferred into the tank 1, and recovered.

In Step S29, the filler recovered in the tank 111 is discarded, or recovered and stored in the resin bottle 114. When the filler is recovered in the resin bottle 114, the first valve V1 opens the path between the first pipe L1 and the second pipe L2, and closes a path between the first pipe L1 and the second pipe L2, and the fifth pipe L5. Additionally, the second valve V2 opens the path between the third pipe L3 and the fourth pipe L4, and closes the path between the third pipe L3 and the fourth pipe L4, and the sixth pipe L6. In this state, when the pump 113 is driven such that the liquid flows from the second pipe L2 to the third pipe L3 while the stirring bar 112b is rotated, and the slurry stored in the tank 111 is stirred, the slurry in the tank 111 is sucked from the first pipe L1, and discharged into the resin bottle 114 from the discharge port 116 through the pipes, the pump, and the valves, and is recovered.

According to this embodiment, slurry can be stably transferred to the first column 12 without allowing the filler to stick to the inside of each pipe, and reducing the flow speed of the slurry in each pipe, or blocking the pipes by the slurry.

In Step S23 of the column processing method, in place of the scale, other measuring instrument or the like may be provided in the tank 111, and the volume of filler may be measured by use of the measuring instrument or the like. In Step S24, the fifth valve V5 may be opened. Consequently, the liquid in the first column 12 is transmitted through the filter 123 to be discharged to the outside, and only the filler is stored in the first column 12.

In the first to third recovery processes, the stirring bar 112b may be suitably rotated to stir the slurry in the tank 111.

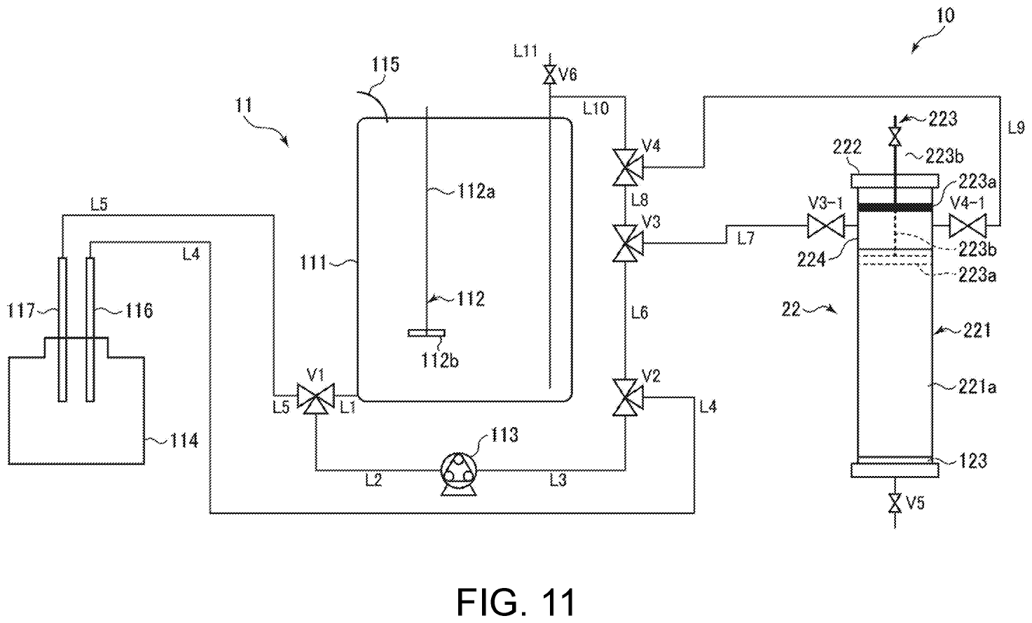

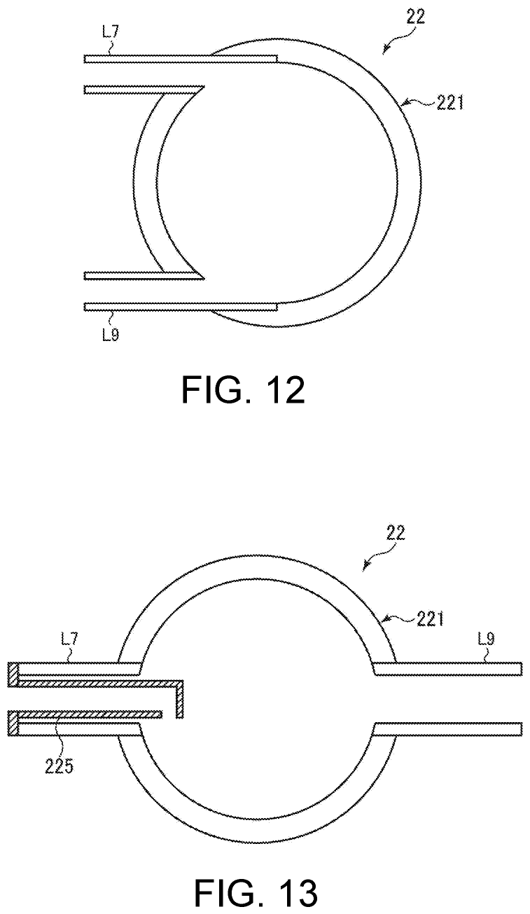

Now, a second column 22 according to a second embodiment will be described with reference to FIGS. 11 and 12. The second column 22 mainly includes a bottomed cylindrical second column tube 221, a lid 222, an adapter pipe 224, and a filter 123. FIG. 12 is a sectional view formed by cutting a portion, in which the seventh pipe L7 and the ninth pipe L9 are connected to the second column tube 221, by a plane orthogonal to the axis of the second column tube 221.

The adapter pipe 224 is a cylindrical member having the same outer diameter and inner diameter as the second column 22, and has pipe mounting ports being two through holes in a side surface. The seventh pipe L7 and the ninth pipe L9 are connected to the respective pipe mounting ports through two-way valves V3-1 and V4-1. The adapter pipe 224 is coaxially mounted on a top of the second column 22. In this state, a leading end of the seventh pipe L7 penetrates the side surface to reach an inner circumferential surface from an outer part of the second column 22, but does not protrude inward, and is provided in such a shape and such a position that slurry discharged from the leading end swirls inside the second column tube 221 (refer to FIG. 12). In this state, the pipe mounting ports are provided between an axial end near a filling completion position, and the filling completion position in the second column tube 221. In this embodiment, the second column tube 221 and the adapter pipe 224 form a column body.

The lid 222 is made of disk-like resin or metal, includes a hole penetrating along the central axis, and is mounted on a top opening of the second column tube 221. An adapter 223 includes a piston 223a and an inlet pipe 223b. The piston 223a is made of disk-like resin or metal having such size as to enable engagement with the inner circumferential surface of the second column tube 221, and includes a hole axially penetrating along the central axis. The inlet pipe 223b is made of cylindrical resin or metal, and is connected to the piston 223a such that the hole of the piston 223a and an inner circumference of the inlet pipe 223b are connected. The inlet pipe 223b is slidably inserted into the through hole provided in the lid 222. In a state in which the lid 222 is mounted on the second column tube 221, the piston 223a can be moved axially in the second column tube 221 by axial movement of the inlet pipe 223b. As described above, the leading end of the seventh pipe L7 does not protrude inside the second column 22, and therefore the piston 223a can move from the axial end near the filling completion position of the second column tube 221 to a position beyond the filling completion position.

When the piston 223a moves to the vicinity of the lid 222, the seventh pipe L7 and the ninth pipe L9 are connected to a filler filling region 221a in the second column tube 221. In this state, slurry can be filled or recovered in the second column tube 221 through the seventh pipe L7 and the ninth pipe L9. On the other hand, when the piston 223a is moved into the filler filling region 221a, the piston 223a compresses the filler. Consequently, the filler is filled in the second column 22. At this time, the seventh pipe L7 and the ninth pipe L9 are disconnected from the filler filling region 221a.

In Steps S21 to S25, S27, and S29 in the column processing method, the piston 223a is moved to the vicinity of the lid 222, so that the second column 22 can be used in a manner similar to the first embodiment. Description of these steps will be omitted. In Step S26 of the column processing method, the piston 223a is moved into the filler filling region 221a without detaching the lid 222. Consequently, the filler is compressed up to a predetermined compress ratio by the piston 223a, and the filler is filled in the second column 22.

As to a connection state between the seventh pipe L7 and the ninth pipe L9, and the second column 22, an example of the connection state different from FIG. 12 is illustrated in FIG. 13. FIG. 13 is a sectional view formed by cutting a portion, in which the seventh pipe L7 and the ninth pipe L9 are connected to the second column tube 221, by the plane orthogonal to the axis of the second column tube 221. In FIG. 13, the seventh pipe L7 and the ninth pipe L9 are connected to the second column 22 at an angle orthogonal to the axis of the second column 22. While the leading ends of the seventh pipe L7 and the ninth pipe L9 penetrate the side surface of the second column 22 to reach the inner circumference, the leading ends of the seventh pipe L7 and the ninth pipe L9 do not protrude to the inner part of the second column 22. On the inner circumference of the seventh pipe L7, a flow-out direction adjustment pipe 225 is mounted. A leading end of the flow-out direction adjustment pipe 225 protrudes to the inner part of the second column 22, and is covered so as to dam with respect to the opening direction, and to open to the lateral side. Consequently, slurry discharged from the leading end swirls in the second column tube 221.

This embodiment obtains the same effects as the first embodiment. Additionally, it is possible to fill the filler in the second column 22 without detaching the lid 222.

In FIGS. 12 and 13, the leading end of the seventh pipe L7 and the leading end of the ninth pipe L9 connected to the second column 22 may be provided at the same position with respect to the axial direction, or may be provided at different positions. In FIGS. 12 and 13, the seventh pipe L7 and the ninth pipe L9 may be mutually interchanged. In FIG. 13, the flow-out direction adjustment pipe 225 may not be mounted.

In any embodiment, two-way valves may be used in place of three-way valves. At this time, the single two-way valve can be provided in each pipe.

The first column tube 121 and the second column tube 221 may not be made of resin, and all or a part of each of the first column tube 121 and the second column tube 221 may be made of a metal material or a glass material.

The outer diameter of the filter 123 may be substantially the same as the inner diameters of the first column tube 121 and the second column tube 221. In this case, the outer diameter of the filter 123 only needs to be such a length as to block at least a hole formed by opening in the inner part of each of the first column tube 121 and the second column tube 221 by the fifth valve V5, and is preferably closer to the inner diameters of the first column tube 121 and the second column tube 221. The outer diameter of the filter 123 may be provided so as to be embedded with respect to the axial direction in a member forming a bottom of each of the first column tube 121 and the second column tube 221.

The stirrer 112 may not be a stirrer that does not include the stirring bar 112b mounted on the leading end of a rotary shaft 112a, and may be a magnetic type stirrer. In this case, a magnetized stirring bar is disposed in the tank 111, and is rotated by magnetic force through a wall of the tank 111. Consequently the stirring bar stirs slurry.

The leading end of the seventh pipe L7 may not be provided in such a shape and such a position as to form swirl, or may be a linear shape. Additionally, the leading end of the seventh pipe L7 may not protrude to the inner part of the first column 12, and may be provided so as to penetrate the lid 122 up to such a position as to be substantially flush with a surface inside the first column 12 in the lid 122.

In Step S25, the sixth valve V6 may be opened or blocked. As described above, the sixth valve V6 is installed on the upper side in the gravity direction with respect to the first column 12. Therefore, the sixth valve V6 is opened, so that atmospheric pressure is applied to the inside of the first column 12 through the tenth pipe L10 and the ninth pipe L9. Consequently, discharge of liquid from the fifth valve V5 is facilitated. Therefore, the sixth valve V6 is opened or blocked, so that it is possible to adjust a reflux speed of slurry from the first column 12 to the tank 111. At this time, the sixth valve V6 is opened or blocked so that the slurry does not jet from the eleventh pipe L11. Alternatively, in a case where the inner diameter of the pipe extending from the sixth valve V6 to the inside of the tank 111 has such a size as not to interrupt reflux of the slurry, it is estimated that the slurry does not jet from the eleventh pipe L11, and therefore the sixth valve V6 can be normally opened, or omitted.

### EMBODIMENT

Now, Examples 1 to 3 according to the first and second embodiments will be indicated, and the effects of the first and second embodiments will be described. The technical scope of the present invention is not limited by these examples at all.

### Example 1: Column Filling Evaluation

(1) Steps S23 to S27 were implemented as described below by using a configuration illustrated in FIG. 6 under an evaluation condition indicated in Table 1.

### Step S23

A filler over column volume and pure water were mixed in a tank, and slurry whose concentration was 50 vol % was prepared.

### Step S24

A A column was assembled, and pure water was filled in a column from a bottom in order to prevent bubbles from entering the column.
B A lid composed of a silicon plug for filling was mounted on a top opening of the column.
C As illustrated in FIG. 6, a tank, a pump, a column, pipes, and valves were assembled.
D Slurry was stirred by a stirrer.
E The pump was activated, and the slurry was fed into the column.

### Step S25

A fifth valve V5 was opened after feeding, an accumulating speed of the filler, and a draining amount from a column lower part were checked until the settling height of the filler in the column reaches 45 cm (90% of column volume).

### Step S26

The adapter was mounted on the top opening of the column, and the filler was compressed in the vertical direction.

### Step S27

A filling state was evaluated by chromatographic analysis. An evaluation condition by the chromatographic analysis is as follows:
Evaluation Sample: 2% acetone
Mobile Phase: pure water
Linear Speed: 30 cm/hr
Equilibrating: 1 column volume
Elution: 1.3 column volume

TABLE 1

| | | |
|---|---|---|
| Column Volume | 3.9 | L |
| Slurry Concentration | 50 | vol % |
| Filler Volume | 4.2 | L |
| Slurry Volume | 8.4 | L |
| Revolution Number of Stirring | 100 | rpm |
| Revolution Number of Pump | 100 | rpm |
| Draining-Slurry Recovering Height Difference | 62 | cm |
| Feeding Amount (After Filling) | 620 | mL/min |
| Slurry Concentration (After Filling) | 23 | vol % |

Herein, the “Revolution Number of Stirring” is the revolution number of the stirrer, and the “Revolution Number of Pump” is the revolution number of the pump. Additionally, the “Draining-Slurry Recovering Height Difference” is a distance from a slurry surface in the tank to a liquid level at which liquid is discharged from a tank bottom to the outside. The “Feeding Amount (After Filling)” is an amount of feeding slurry to the column in a period during which slurry is filled in the column. The “Slurry Concentration (After Filling)” is the concentration of slurry that remains in the tank 111 after filling of slurry into the column is completed.

Now, an evaluation result is listed.

The settling height of the filler in the column is listed in Table 2.

TABLE 2

| Time | Filler Height | Draining Amount |
|---|---|---|
| min | cm | kg |
| 0 | 0 | 0 |
| 1 | 0 | 0.28 |
| 3 | 1.6 | 0.765 |
| 5 | 3.3 | 1.13 |
| 10 | 8.5 | 1.75 |
| 15 | 13.1 | 2.16 |
| 20 | 16.9 | 2.48 |
| 25 | 20.2 | 2.75 |
| 30 | 23.3 | 2.985 |
| 35 | 26.1 | 3.19 |
| 40 | 28.6 | 3.375 |
| 45 | 31 | 3.545 |
| 50 | 33.3 | 3.7 |
| 55 | 35.4 | 3.85 |
| 60 | 37.3 | 3.99 |
| 70 | 40.8 | 4.245 |
| 80 | 43.7 | 4.48 |
| 85 | 45.1 | 4.595 |

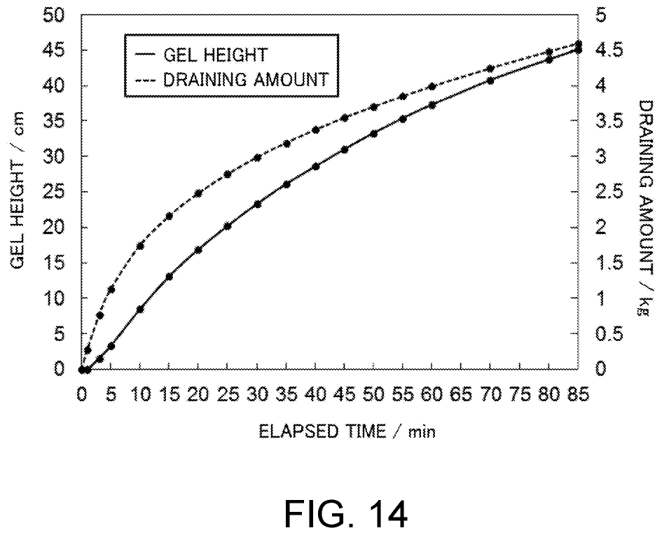

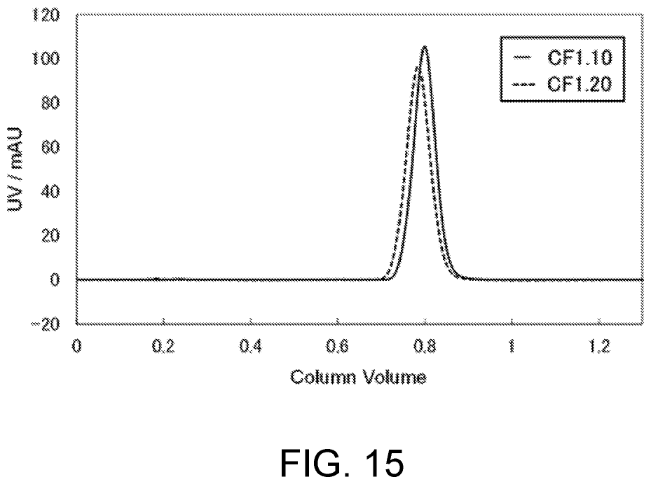

Time change of an draining amount from the fifth valve is illustrated in FIG. 14, and chromatographic analysis result after filling is illustrated in FIG. 15 and Table 3.

TABLE 3

| Compression Factor | Bed Height | Asymmetry | Plates/Meter |
|---|---|---|---|
| [—] | [cm] | [—] | [N/m] |
| 1.10 | 31.5 | 0.99 | 3503 |
| 1.20 | 28 | 1.06 | 3159 |

The chromatography resulted in one mountain having excellent symmetry, and in excellent number of theoretical plates.

### Example 2: Column Filling Evaluation

A distance from a slurry surface in the tank 111 to a liquid level at which liquid is discharged from a tank bottom to the outside is set to 16.5 cm, 21.5 cm, and 44.5 cm, and a flow-out liquid amount per unit time from a column bottom was measured by a graduated cylinder in a state in which resin of about 7 cm (70% of column volume) was settled in a column having an inner diameter of 1 cm, a pipe height of 10.6 cm, capacity of 0.79 cm², and column volume (CV) of 8.4 mL, and in a state in which remaining slurry of 20% is circulated, and the flow-out speed was obtained.

The evaluation result is listed. The flow-out speed in a case in which the distance was set to 16.5 cm was 0.38 mL/min, the flow-out speed in a case in which the distance was set to 21.5 cm was 0.45 mL/min, and the flow-out speed in a case in which the distance was set to 44.5 cm was 0.75 mL/min. It was confirmed that the longer the distance from the slurry surface in the tank 111 to the liquid level at which the liquid is discharged from the tank bottom to the outside was, that is, the higher the water head was, the faster the flow-out speed was.

### Example 3: Column Filling Evaluation

A distance from a slurry surface in the tank 111 to a liquid level at which liquid is discharged from a tank bottom to the outside is set to 16.5 cm, slurry of 15.2 mL containing resin having column volume (CV) of 90% (7.6 mL) was circulated in a column having an inner diameter of 1 cm, a pipe height of 10.6 cm, capacity of 0.79 cm², and column volume (CV) of 8.4 mL, and an amount of a filler settled inside a column was measured.

The evaluation result is listed. The amount of the settled filler was 70%. The resin could be transferred to the column without blocking pipes by slurry, and settled into the column.

The sizes of the respective members described in this specification and illustrated in the drawings are an example, and the present invention is not limited to these sizes. Additionally, materials of the respective members are an example, and the present invention is not limited to these materials.

Although the embodiment of the present invention is described with reference to the accompanying drawings, it will be obvious to those skilled in the art that a structure and relation of each component may be modified within the scope and spirit of the present invention described herein.

What is claimed is:

1. A column filling apparatus comprising:
a tank storing liquid and a filler;
a transfer pipe transferring slurry from the tank to a column, the slurry comprising the liquid and the filler; and
a reflux pipe for refluxing the slurry from the column to the tank.

2. The column filling apparatus according to claim 1, wherein the transfer pipe allows the slurry to flow into the column from an upper side with respect to a filling completion position of the filler in the column.

3. The column filling apparatus according to claim 1, wherein the reflux pipe takes out the slurry from the column from an upper side with respect to a filling completion position of the filler in the column.

4. The column filling apparatus according to claim 1, wherein the transfer pipe takes out the slurry from a vicinity of a bottom of the tank.

5. The column filling apparatus according to claim 1, wherein the transfer pipe includes a pump that transfers the slurry from the tank to the column.

6. The column filling apparatus according to claim 1, further comprising an agitator that is provided in the tank, and mixes the liquid and the filler.

7. The column filling apparatus according to claim 1, further comprising:
a container storing the liquid and the filler;
a container take-out pipe taking out the liquid and the filler from the container; and
a container return pipe returning, to the container, the liquid and the filler taken out by the container take-out pipe, wherein
the transfer pipe includes a pump that pressure-feeds the slurry from the tank to the column, a first valve provided between the tank and the pump, and a second valve provided between the pump and the column,
the container take-out pipe is connected to the first valve,
the container return pipe is connected to the second valve,
the first valve closes a path between the transfer pipe and the tank, and opens a path between the transfer pipe and the container take-out pipe,
the second valve closes a path between the transfer pipe and the column, and opens a path between the transfer pipe and the container return pipe, and
the pump takes out the liquid and the filler from the container through the container take-out pipe, and returns the liquid and the filler to the container through the container return pipe.

8. The column filling apparatus according to claim 1, further comprising:
a container storing the liquid and the filler; and
a container take-out pipe taking out the liquid and the filler from the container, wherein
the transfer pipe includes a pump that pressure-feeds the slurry from the tank to the column, a first valve provided between the tank and the pump, and a third valve provided between the pump and the column,
the reflux pipe includes a fourth valve provided between the column and the tank,
a pipe connecting the third valve and the fourth valve is provided,
the container take-out pipe is connected to the first valve,
the first valve closes a path to the tank in the transfer pipe, and opens a path from the container take-out pipe to the transfer pipe,
the third valve closes a path to the column in the transfer pipe, and opens a path from the pump to the pipe,
the fourth valve closes a path to the column in the reflux pipe, and opens a path from the pipe to the tank, and
the pump takes out the liquid and the filler from the container through the container take-out pipe, and transfers the liquid and the filler to the tank.

9. The column filling apparatus according to claim 1, further comprising:
a container storing the liquid and the filler;
a tank take-out pipe taking out the liquid from the tank; and
a container return pipe returning, to the container, the liquid taken out by the tank take-out pipe, wherein
the transfer pipe includes a pump that pressure-feeds the slurry from the tank to the column, a first valve provided between the tank and the pump, and a second valve provided between the pump and the column,
the tank take-out pipe is connected to the first valve,
the container return pipe is connected to the second valve,
the first valve closes a path between the transfer pipe and the tank, and opens a path between the transfer pipe and the tank take-out pipe,
the second valve closes a path between the transfer pipe and the column, and opens a path between the transfer pipe and the container return pipe, and
the pump takes out the liquid from the tank through the tank take-out pipe, discharges the liquid to outside through the container return pipe, and adjusts concentration of the filler to the liquid.

10. The column filling apparatus according to claim 1, further comprising a column bottom valve provided in a bottom of the column, wherein the column bottom valve allows the liquid in the column to flow out to outside.

11. The column filling apparatus according to claim 1, further comprising
a tank take-out pipe that takes out the liquid from the tank, wherein
the transfer pipe includes a pump that pressure-feeds the slurry from the tank to the column, and a first valve provided between the tank and the pump,
the tank take-out pipe is connected to the first valve,
the first valve closes a path between the transfer pipe and the tank, and opens a path between the transfer pipe and the tank take-out pipe,
the pump takes out the liquid from the tank through the tank take-out pipe, discharges the liquid to the column through the transfer pipe, and produces slurry by mixing the filler and the liquid in the column, and
the reflux pipe refluxes the slurry from the column to the tank.

12. The column filling apparatus according to claim 1, further comprising
a tank take-out pipe that takes out the liquid from the tank, wherein
the transfer pipe includes a pump that pressure-feeds the slurry from the tank to the column, and a second valve provided between the pump and the column,
a column bottom valve that is provided in a bottom of the column, and allows the liquid in the column to flow out to outside, and a column bottom connection pipe connecting the second valve and the column bottom valve are further provided,
the second valve opens a path between the transfer pipe and the column bottom connection pipe, and
the pump takes out the liquid from the tank through the tank take-out pipe, and injects the liquid from the bottom of the column to inside through the column bottom connection pipe and the column bottom valve.

13. The column filling apparatus according to claim 1, further comprising:
a container take-out pipe that takes out at least the liquid from the column; and
a container return pipe that returns, to the column, the liquid taken out by the container take-out pipe, wherein
the transfer pipe includes a pump that pressure-feeds the slurry from the tank to the column, a first valve provided between the tank and the pump, and a second valve provided between the pump and the column,
the container take-out pipe is connected to the first valve,
the container return pipe is connected to the second valve,
the first valve closes a path between the transfer pipe and the tank, and opens a path between the transfer pipe and the container take-out pipe,
the second valve closes a path between the transfer pipe and the column, and opens a path between the transfer pipe and the container return pipe, and
the pump takes out at least the liquid from the column through the container take-out pipe, returns at least the liquid to the column through the container return pipe, and produces slurry by mixing the filler and the liquid in the column.

14. The column filling apparatus according to claim 1, wherein a slurry surface in the tank is disposed on an upper side in a gravity direction with respect to a liquid level at which the liquid is discharged to outside in the column.

15. A column processing method comprising the steps of:
storing liquid and a filler in a tank;
transferring slurry from the tank to a column, the slurry comprising the liquid and the filler; and
refluxing the slurry from the column to the tank.

16. A column comprising:
a cylindrical column body capable of filling a filler up to a filling completion position; and
a pipe mounting port provided between an axial end near the filling completion position and the filling completion position on a side surface of the column body.

17. The column according to claim 16, comprising
a piston capable of axially moving inside the column body, and capable of compressing the filler, wherein
the piston is capable of moving beyond the filling completion position from the axial end near the filling completion position.

18. A column filling system comprising:
a column comprising a cylindrical column body; and
a column filling apparatus according to claim 1, wherein
the column filling apparatus includes a lid that detachably blocks an axial end of the column body, and
the transfer pipe and the reflux pipe penetrate the lid to be inserted into the column body.

19. A column filling system comprising:
a column filling apparatus according to claim 1; and
a column comprising:
a cylindrical column body capable of filling a filler up to a filling completion position; and
a pipe mounting port provided between an axial end near the filling completion position and the filling completion position on a side surface of the column body.
